(19) United States
(12) Patent Application Publication
(10) Pub. No.: US 2013/0293801 A1
(43) Pub. Date: Nov. 7, 2013

(54) DISPLAY PANEL AND DISPLAY DEVICE WITH SAME

(71) Applicant: Katsuhiro Okada, Osaka (JP)

(72) Inventor: Katsuhiro Okada, Osaka (JP)

(73) Assignee: SHARP KABUSHIKI KAISHA, Osaka (JP)

(21) Appl. No.: 13/979,836

(22) PCT Filed: Jan. 12, 2012
(86) PCT No.: PCT/JP2012/050432

§ 371 Date: Jul. 15, 2013

(30) Foreign Application Priority Data
Jan. 19, 2011 (JP) 2011-008871

(51) Int. Cl. G02F 1/1362

(52) U.S. Cl. CPC G02F 1/136209
USPC 349/43

(57) ABSTRACT

Provided is a display panel in which the adhesive strength between two substrates can be increased. This display panel is provided with: a glass substrate (1) having an interlayer insulating film (14) formed thereon; a glass substrate (2) having formed thereon a black matrix layer (17) and a opposite electrode (13); and a sealing member (3) disposed along the outer periphery of the glass substrate (2), the outer periphery including the corners (2b) of the glass substrate (2). Cut-outs (14b) are formed in the portions (14a) of the interlayer insulating film (14) which are superposed on the corners (2b), cut-outs (17b) are formed in the portions (17a) of the black matrix layer (17) which are located at the corners (2b), and cut-outs (13b) are formed in the portions (13a) of the opposite electrode (13) which are located at the corners (2b).

### TECHNICAL FIELD

The present invention relates to a display panel and a display device provided with the same.

### BACKGROUND ART

Conventionally, as a display device, a liquid crystal display device that conducts display by relying on changes in optical properties of liquid crystal is known (refer to Patent Document 1, for example).

Normally, in a conventional liquid crystal display device, two substrates are disposed facing each other, and a liquid crystal layer is sandwiched between the two substrates.

As a specific configuration, on a prescribed surface of one of the two substrates, TFTs (thin film transistors) connected to pixel electrodes, an interlayer insulating film (organic film) covering the TFTs, and the like are formed. On a prescribed surface of the other of the two substrates, a black matrix layer (organic film) functioning as a light-shielding layer, an opposite electrode (ITO film) that generates an electric field between the opposite electrode and the pixel electrodes, and the like are formed. The two substrates are bonded together with a sealing member such that the respective prescribed surfaces of the substrates face each other.

The sealing member that bonds together the two substrates is disposed between the two substrates along the outer edge of a display region so as to surround the display region. The liquid crystal layer sandwiched between the two substrates is sealed inside the display region by the sealing member.

### RELATED ART DOCUMENT

### Patent Document

Patent Document 1: Japanese Patent Application Laid-Open Publication No. 2009-180915

### SUMMARY OF THE INVENTION

### Problems to be Solved by the Invention

In the above-mentioned conventional configuration, there are cases in which a sealing member is disposed between an interlayer insulating film provided on one substrate and an opposite electrode provided on the other substrate, and the two substrates are bonded to each other by bonding the interlayer insulating film and the opposite electrode to each other with the sealing member. In such a case, the adhesion between the interlayer insulating film and the sealing member is not very strong, and the adhesion between the opposite electrode and the sealing member is also not very strong, and as a result, the adhesive strength between the two substrates is low. In other words, the two substrates are susceptible to detachment from each other, which causes defects such as liquid crystal leaking out from between the two substrates, for example.

The present invention was made in order to solve the above mentioned problem, and an object thereof is to provide a display panel in which the adhesive strength between the two substrates can be increased, and a display device provided therewith.

### Means for Solving the Problems

In order to achieve the above-mentioned object, a display panel according to a first aspect of the present invention includes: a first substrate having a first surface, the first surface having formed thereon switching elements connected to pixel electrodes and an insulating film covering the switching elements; a second substrate having a second surface facing the first surface, the second surface having formed thereon a black matrix layer as a light-shielding layer and an opposite electrode that generates an electric field between the opposite electrode and the pixel electrodes; and a sealing member disposed between the first substrate and the second substrate along an outer periphery of the second substrate that includes a corner thereof, the sealing member bonding together the first substrate and the second substrate. A cut-out is formed in a portion of the insulating film corresponding in position to the corner of the second substrate, and cut-outs are respectively formed in a portion of the black matrix layer at the corner of the second substrate and a portion of the opposite electrode at the corner of the second substrate.

In the display panel of the first aspect, as described above, when disposing a sealing member (member for bonding together the first substrate and the second substrate) between the first substrate and the second substrate along the outer periphery of the second substrate including the corners thereof, cut-outs are formed in portions of the insulating film (film formed on the first surface of the first substrate) corresponding in position to the corners of the second substrate, thus exposing prescribed portions of the first surface of the first substrate (portions thereof overlapping portions of the sealing member) corresponding in position to the corners of the second substrate, and it is possible to have the sealing member directly bonded to the prescribed portions of the first surface of the first substrate. In addition, cut-outs are formed in portions of the black matrix layer at the corners of the second substrate, and portions of the opposite electrode at the corners of the second substrate, and thus, the corners (portions overlapping portions of the sealing member) of the second surface of the second substrate are also exposed. Thus, it is possible to also directly bond the sealing member to the corners of the second surface of the second substrate. As a result, the adhesive strength between the first substrate and the second substrate is increased.

If the adhesive strength between the first substrate and the second substrate can be increased, then it is possible to mitigate a leakage of the liquid crystal layer from between the first substrate and the second substrate if a liquid crystal layer is disposed between the first substrate and the second substrate.

If normally unnecessary cut-outs are formed in the black matrix layer, light leaks therethrough, which sometimes has a negative visual effect. However, in the display panel of the first aspect, cut-outs are formed in portions of the black matrix layer at the corners of the second substrate (in other words, portions at the vicinity of the corners of the display region), and thus, there is not much negative visual effect.

In the display panel according to the first aspect, it is preferable that when the second substrate has a plurality of corners, the cut-out be formed in every portion of the insulating film corresponding in position to each of the plurality of corners of the second substrate, and that the cut-out be formed in every portion of the black matrix layer positioned at each of the plurality of corners of the second substrate, and in every portion of the opposite electrode positioned at each of the plurality of corners of the second substrate. With this configuration, the area in which the sealing member is directly bonded to the first surface of the first substrate is increased, and the area in which the sealing member is directly bonded to the second surface of the second substrate is also increased. Therefore, the adhesive strength between the first substrate and the second substrate is further increased.

It is preferable that the display panel according to the first aspect further include pad electrodes disposed on the insulating film, the pad electrodes supplying an electrical signal to the opposite electrode, wherein the pad electrodes are disposed on portions of the insulating film other than the portion where the cut-out is formed. With this configuration, prescribed portions of the first surface of the first substrate (portions where the sealing member is to be directly bonded) are not blocked by the pad electrodes. Thus, even in a configuration in which the pad electrodes are formed on the insulating film, the sealing member can be directly bonded onto prescribed portions of the first surface of the first substrate with ease.

In a configuration in which the pad electrodes are formed on the insulating film, when a common wiring line connected to the pad electrodes is formed on the first surface of the first substrate, it is preferable that the common wiring line be drawn so as to avoid the portion of the first surface of the first substrate corresponding in position to the corner of the second substrate. With this configuration, prescribed portions of the first surface of the first substrate (portions where the sealing member is to be directly bonded) are not blocked by the common wiring line. Thus, even in a configuration in which the common wiring line is formed on the first surface of the first substrate, the sealing member can be directly bonded onto prescribed portions of the first surface of the first substrate with ease.

In the display panel according to the first aspect, it is preferable that the cut-out be formed in a portion of the outer periphery of the black matrix layer surrounding a display region, and that a minimum distance from an edge of the outer periphery of the black matrix layer to the display region in a portion where the cut-out is formed be no less than a minimum distance from an edge of the outer periphery of the black matrix layer to the display region in a portion where the cut-out is not formed.

In the display panel according to the first aspect, among the cut-out of the insulating film, the cut-out of the black matrix layer, and the cut-out of the opposite electrode, at least two thereof may be the same shape.

A display device according to a second aspect of the present invention includes the display panel according to the first aspect. With a display device configured in this manner, the adhesive strength between the first substrate and the second substrate can be increased.

### Effects of the Invention

As stated above, according to the present invention, it is possible to obtain with ease a display panel and a display device in which the adhesive strength between the first substrate and the second substrate can be increased.

### BRIEF DESCRIPTION OF THE DRAWINGS

FIG. 1 is a perspective view of a liquid crystal display device (liquid crystal display panel and backlight unit) according to one embodiment of the present invention.

FIG. 2 is a circuit diagram of a subpixel formed in the liquid crystal display panel shown in FIG. 1.

FIG. 3 is a cross-sectional view of a portion of the liquid crystal display panel (portion corresponding to a subpixel) shown in FIG. 1.

FIG. 4 is a plan view of an interlayer insulating film provided on one glass substrate of the liquid crystal display panel shown in FIG. 1.

FIG. 5 is a plan view of a black matrix layer provided on the other glass substrate of the liquid crystal display panel shown in FIG. 1.

FIG. 6 is a plan view of an opposite electrode provided on the other glass substrate of the liquid crystal display panel shown in FIG. 1.

FIG. 7 is a plan view of a situation in which the sealing member overlaps the other glass substrate of the liquid crystal display panel shown in FIG. 1.

FIG. 8 shows a situation in which the one glass substrate and the other glass substrate of the liquid crystal display panel shown in FIG. 1 are bonded together by the sealing member.

FIG. 9 is a magnified view of a portion of a common wiring line provided on one glass substrate of the liquid crystal display panel shown in FIG. 1.

FIG. 10 is a modification example of an embodiment of the present invention (in which the sealing member is bonded to a gate insulating film).

FIG. 11 is a modification example of an embodiment of the present invention (modification example of a cut-out shape).

FIG. 12 is a modification example of an embodiment of the present invention (modification example of a cut-out shape).

FIG. 13 is a modification example of an embodiment of the present invention (modification example of a cut-out shape).

FIG. 14 is a modification example of an embodiment of the present invention (modification example of a cut-out shape).

FIG. 15 is a modification example of an embodiment of the present invention (modification example of a cut-out shape).

FIG. 16 is a modification example of an embodiment of the present invention (modification example of a cut-out shape).

FIG. 17 shows a method of forming an ITO layer (layer to become the opposite electrode) on a mother glass.

### DETAILED DESCRIPTION OF EMBODIMENTS

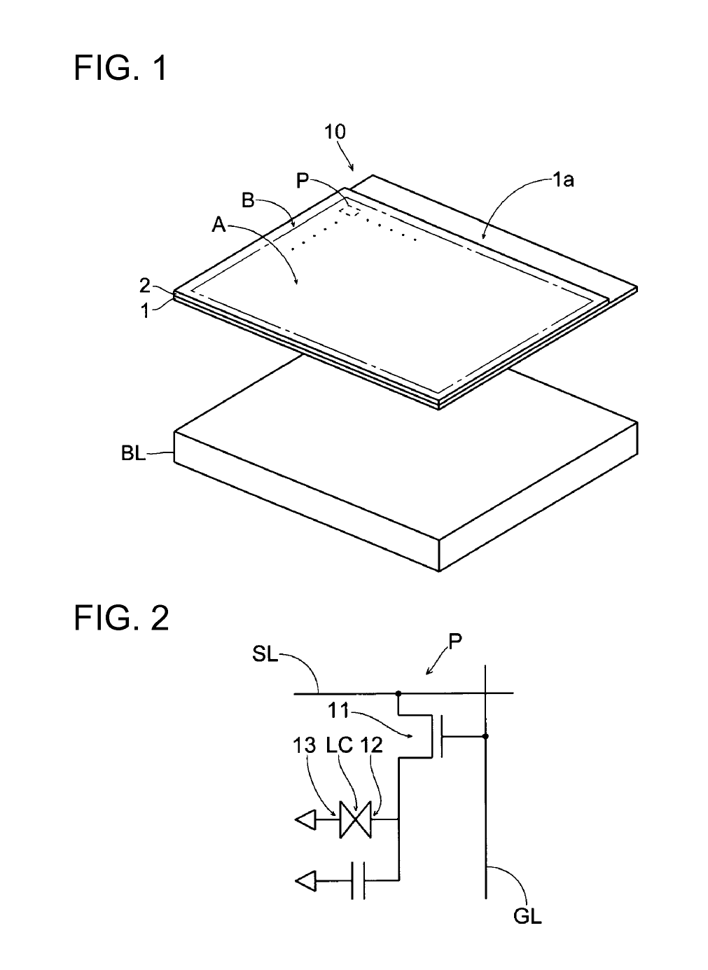

A display device according to an embodiment of the present invention will be described with reference to FIGS. 1 to 9.

The display device of the present embodiment is a liquid crystal display device, and as shown in FIG. 1, includes at least a liquid crystal display panel 10, and a backlight unit BL disposed on a rear side opposite to the display surface side of the liquid crystal display panel 10. The liquid crystal display panel 10 is an example of the “display panel” of the present invention.

The liquid crystal display panel 10 has a display region (rectangular region in FIG. 1 surrounded by a long and short dash line) A in which a desired image is actually displayed, and a non-display region B that is an outer edge region (a frame-shaped region that surrounds the display region A). The display region A of the liquid crystal display panel 10 has a plurality of subpixels P arranged therein in a matrix.

The respective plurality of subpixels P correspond to any of the following colors: red (R), green (G), and blue (B). A collection that includes one each of a red (R) subpixel P, a green (G) subpixel P, and a blue (B) subpixel P constitutes one pixel.

Each of the plurality of subpixels P has a circuit configuration as shown in FIG. 2, and is driven by a switching element 11, a pixel electrode 12, an opposite electrode (common electrode) 13, and the like. The circuit configuration of the subpixel P shown in FIG. 2 is only one example, and the configuration is not limited thereto.

The switching elements 11 are constituted of TFTs (thin film transistors), and the gate of each switching element 11 is connected to a gate line (scanning line) GL, and the source of each switching element 11 is connected to a source line (data line) SL. The pixel electrode 12 is connected to the drain of the switching element 11, and the opposite electrode 13 is disposed facing the pixel electrodes 12. A liquid crystal layer LC is sandwiched between the pixel electrodes 12 and the opposite electrode 13. A switching element 11 is provided individually for each subpixel P, and a pixel electrode 12 is provided individually for each subpixel P. On the other hand, the opposite electrode 13 is common to all subpixels P.

The backlight unit BL shown in FIG. 1 emits planar white backlight (illumination light), and illuminates the liquid crystal display panel 10 from the rear. The configuration of the backlight unit BL is not limited and can be appropriately modified depending on the application. In other words, the backlight unit BL may be of a direct light type or an edge light type. The light sources of the backlight unit BL may be CCFLs (cold cathode fluorescent lamps) or LEDs (light emitting diodes).

When conducting display, the optical properties (light transmittance) are individually changed for each of the plurality of subpixels P formed in the liquid crystal display panel 10 based on an image signal. Specifically, at each subpixel P (refer to FIG. 2), electrical power is supplied to the pixel electrode 12 through the switching element 11, and an electric field is generated between the pixel electrode 12 and the opposite electrode 13. As a result, the orientation of liquid crystal molecules in the liquid crystal layer LC, or in other words, the transmittance of light through the liquid crystal layer LC is changed.

Thus, when the liquid crystal display panel 10 is illuminated from the rear by backlight from the backlight unit BL, the transmittance of the backlight through the liquid crystal display panel 10 differs for each subpixel P, and as a result, a desired image is displayed in the display region A of the liquid crystal display panel 10.

The configuration of the liquid crystal display panel 10 is described in more detail below.

The liquid crystal display panel 10 includes at least two glass substrates (transparent substrates) 1 and 2. One glass substrate 1 is an example of the “first substrate” of the present invention, and the other glass substrate 2 is an example of the “second substrate” of the present invention. The one glass substrate 1 is sometimes referred to as a TFT substrate or an active matrix substrate. The other glass substrate 2 is sometimes referred to as an opposite substrate or a color filter substrate (CF substrate).

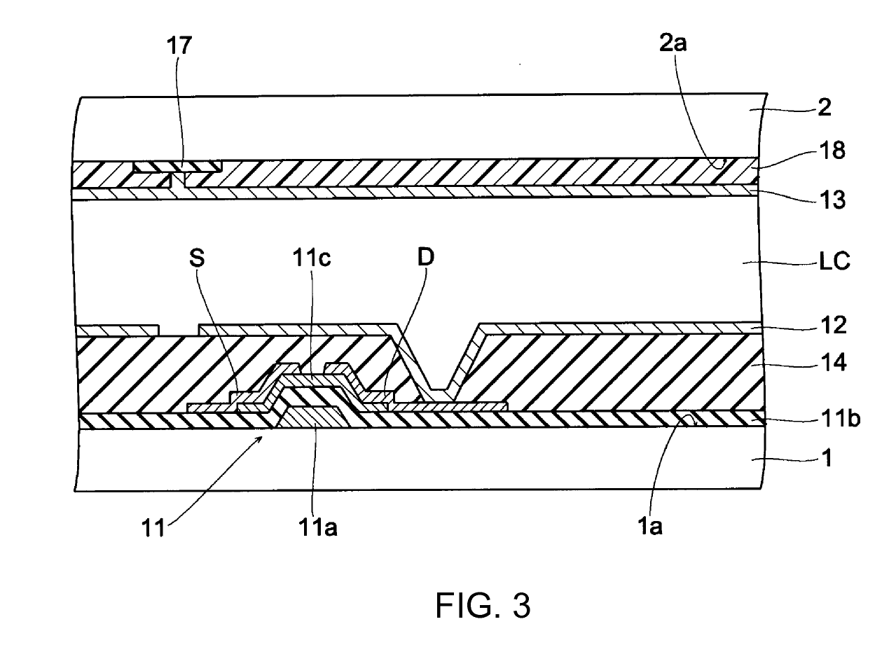

As shown in FIG. 3, the two glass substrates 1 and 2 are bonded together such that respective prescribed surfaces 1a and 2a face each other. The prescribed surface 1a of the glass substrate 1 is an example of the “first surface” of the present invention, and the prescribed surface 2a of the glass substrate 2 is an example of the “second surface” of the present invention.

The two glass substrates 1 and 2 differ in outer shape size; the outer shape size of the glass substrate 1 is greater than the outer shape size of the glass substrate 2. Therefore, as shown in FIG. 1, the two glass substrates 1 and 2 are bonded to each other, but the positions of respective prescribed ends of the glass substrates 1 and 2 do not match, and a portion of the prescribed surface 1a of the glass substrate 1 is not covered by the glass substrate 2. The exposed portion of the prescribed surface 1a of the glass substrate 1 is one region of the non-display region B, and is used in order to connect drivers (not shown in drawings) and the like to the glass substrate 1.

Returning to FIG. 3, the above-mentioned switching element 11 is formed on the prescribed surface 1a of the glass substrate 1. The switching element 11 is structured so as to include a gate electrode 11a formed on the prescribed surface 1a of the glass substrate 1, a gate insulating film (an inorganic insulating film such as an SiNₓ film or an SiOₓ film) 11b formed on the prescribed surface 1a of the glass substrate 1 so as to cover the gate electrode 11a, and a semiconductor layer (layer including a source region and a drain region) 11c formed over the gate electrode 11a through the gate insulating film 11b. The gate insulating film 11b is formed covering not only regions where the gate electrodes 11a are formed, but also regions where the gate electrodes 11a are not formed. In other words, of the prescribed surface 1a of the glass substrate 1, the gate insulating film 11b covers most (but not all) of the region covered by the glass substrate 2.

A source electrode S and a drain electrode D are formed on the switching element 11. The source electrode S is connected to the source region of the semiconductor layer 11c, and the drain electrode D is connected to the drain region of the semiconductor layer 11c.

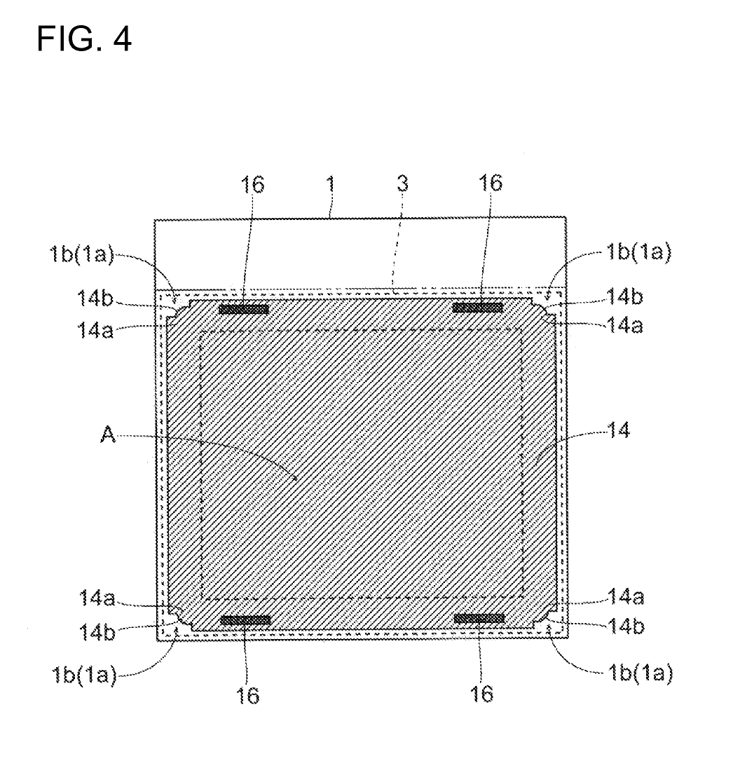

The switching element 11, the source electrode S, and the drain electrode D are covered by an interlayer insulating film (an organic film made of a material such as a photosensitive acrylic resin) 14. All portions of the interlayer insulating film 14 cover the gate insulating film 11b. In other words, the interlayer insulating film 14 covers most (but not all) of the region of the prescribed surface 1a of the glass substrate 1 covered by the glass substrate 2, through the gate insulating film 11b. FIG. 4 schematically shows a plan view shape of the interlayer insulating film 14. The two-dot chain line in FIG. 4 shows the edge of the glass substrate 2.

Returning to FIG. 3, a portion of the interlayer insulating film 14 corresponding to the drain electrode D has a contact hole formed therethrough reaching the drain electrode D. The above-mentioned pixel electrode 12 is formed on the interlayer insulating film 14, and is connected to the drain electrode D through the contact hole in the interlayer insulating film 14.

Although not shown in FIG. 3, on the prescribed surface 1a of the glass substrate 1, a common wiring line 15 (refer to FIG. 9) obtained by patterning the same layer as the gate electrodes 11a is formed, and on the interlayer insulating film 14, pad electrodes 16 (refer to FIG. 4) obtained by patterning the same layer as the pixel electrodes 12 are formed. The common wiring line 15 and the pad electrodes 16 are connected to each other through contact holes formed in prescribed portions (portions sandwiched by the common wiring line 15 and the pad electrodes 16) of the interlayer insulating film 14.

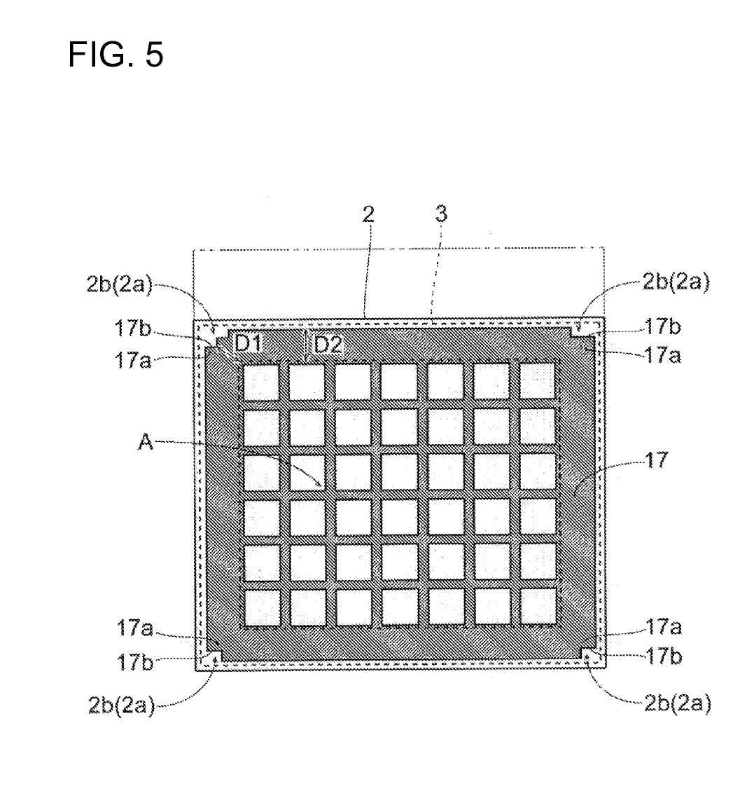

A black matrix layer (light-shielding layer) 17 is formed on the prescribed surface 2a of the other glass substrate 2. The black matrix layer 17 is disposed so as to surround regions corresponding to the respective red (R), green (G), and blue (B) subpixels P. In other words, the black matrix layer 17 divides the regions corresponding to the respective red (R), green (G), and blue (B) subpixels P. The outer periphery (frame portion) of the black matrix layer 17 is formed in a shape following the outer periphery of the glass substrate 2, and is disposed along the outer periphery of the glass substrate 2, and thus, the outer periphery of the black matrix layer 17 surrounds the display region A. FIG. 5 shows a schematic plan view shape of the black matrix layer 17. The two-dot chain line in FIG. 5 shows the edge of the glass substrate 1.

Returning to FIG. 3, color filter layers 18 each having a color corresponding to each of the subpixels P are formed in the respective regions corresponding to the respective red (R), green (G), and blue (B) subpixels P so as to fill the openings of the black matrix layer 17.

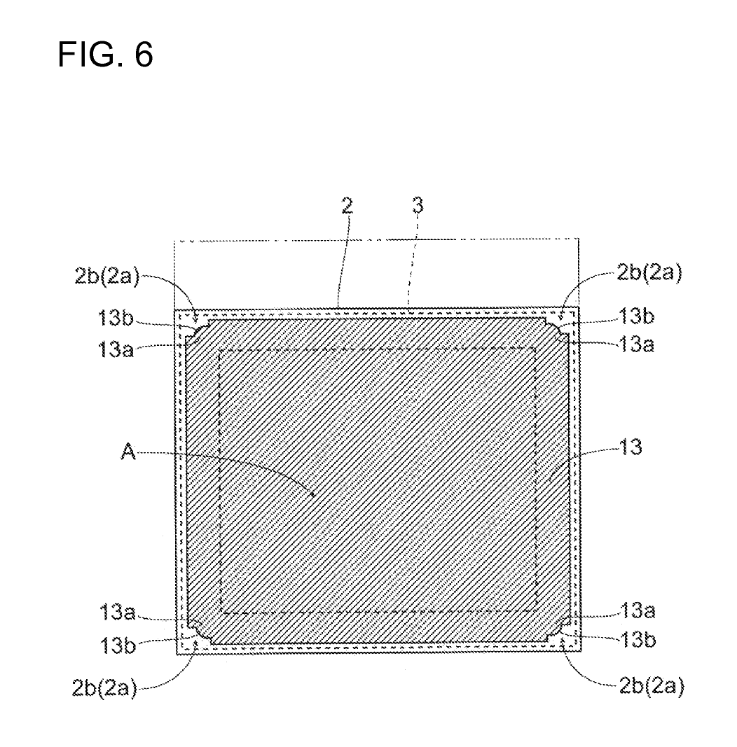

The opposite electrode 13 is formed on a surface of the color filter layer 18 opposite to the glass substrate 2, and covers most (but not all) of the prescribed surface 2a of the glass substrate 2. FIG. 6 schematically shows a plan view shape of the opposite electrode 13. The two-dot chain line in FIG. 6 shows the edge of the glass substrate 1.

Returning to FIG. 3, the above-mentioned liquid crystal layer LC is sandwiched between the prescribed surface 1a of the glass substrate 1 and the prescribed surface 2a of the glass substrate 2. In other words, the liquid crystal layer LC is sandwiched between the pixel electrodes 12 and the opposite electrode 13. Although not shown in drawings, the pixel electrodes 12 and the opposite electrode 13 are respectively covered by alignment films that can orient the liquid crystal molecules in the liquid crystal layer LC in a prescribed direction. Thus, the liquid crystal layer LC is actually sandwiched between a pair of alignment films.

Additionally, although not shown in drawings, the surface of the glass substrate 1 opposite to the prescribed surface 1a and the surface of the glass substrate 2 opposite to the prescribed surface 2a are each provided with one polarizing sheet that only transmits light waves oscillating in a specific direction. The respective transmission axes of the polarizing sheet on the glass substrate 1 and the polarizing sheet on the glass substrate 2 are at approximately 90° with respect to each other.

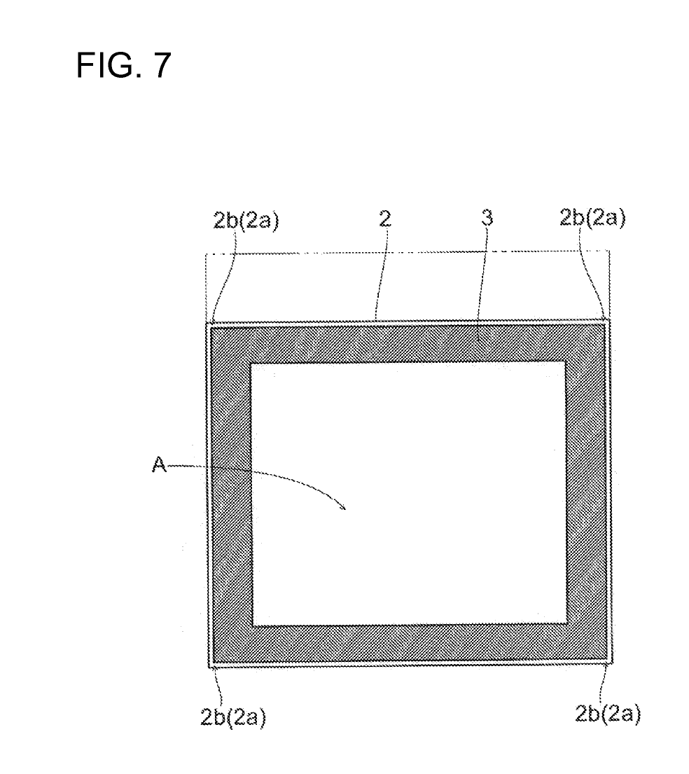

The two glass substrates 1 and 2 are bonded together such that a sealing member 3 (refer to FIG. 7) as an adhesive layer is disposed between the glass substrate 1 and the glass substrate 2. In other words, the glass substrates 1 and 2 are adhesively fixed to each other through the sealing member 3. The material of the sealing member 3 is not limited but an example includes an epoxy acrylic resin.

As shown in FIG. 7, when viewing the sealing member 3 with respect to the glass substrate 2, the sealing member 3 is formed in a rectangular frame shape along the outer periphery of the glass substrate 2 including four corners 2b, and is disposed along the outer periphery including the four corners 2b of the glass substrate 2. In other words, the sealing member 3 surrounds the display area A. The two-dot chain line in FIG. 7 shows the edge of the glass substrate 1.

As shown in FIG. 4, in the present embodiment, when viewing four portions 14a of the interlayer insulating film 14 (including the gate insulating film 11b) respectively corresponding in position to the four corners 2b of the glass substrate 2, cut-outs (openings) 14b are formed in all four portions 14a of the interlayer insulating film 14. As a result, of the prescribed surface la of the glass substrate 1, the four portions 1b respectively correspond in position to the four corners 2b of the glass substrate 2 are exposed.

As shown in FIG. 5, in the present embodiment, when viewing four portions (portions on the outer periphery of the black matrix layer 17) 17a of the black matrix layer 17 respectively located at the four corners 2b of the glass substrate 2, cut-outs (openings) 17b are formed in all four portions 17a of the black matrix layer 17. A minimum distance D1 from the edge of the outer periphery of the black matrix layer 17 to the display region A in a portion 17a where a cut-out 17b is formed is no less than a minimum distance D2 from the edge of the outer periphery of the black matrix layer 17 to the display region A in a portion (portion differing from the portion 17a) where a cut-out 17b is not formed. The distance D1 is 2.0 mm and the distance D2 is 1.8 mm, for example.

Additionally, as shown in FIG. 6, when viewing the four portions 13a of the opposite electrode 13 located respectively in the four corners 2b of the glass substrate 2, cut-outs (openings) 13b are also formed in all four portions 13a of the opposite electrode 13. As a result, the four corners 2b of the prescribed surface 2a of the glass substrate 2 are exposed.

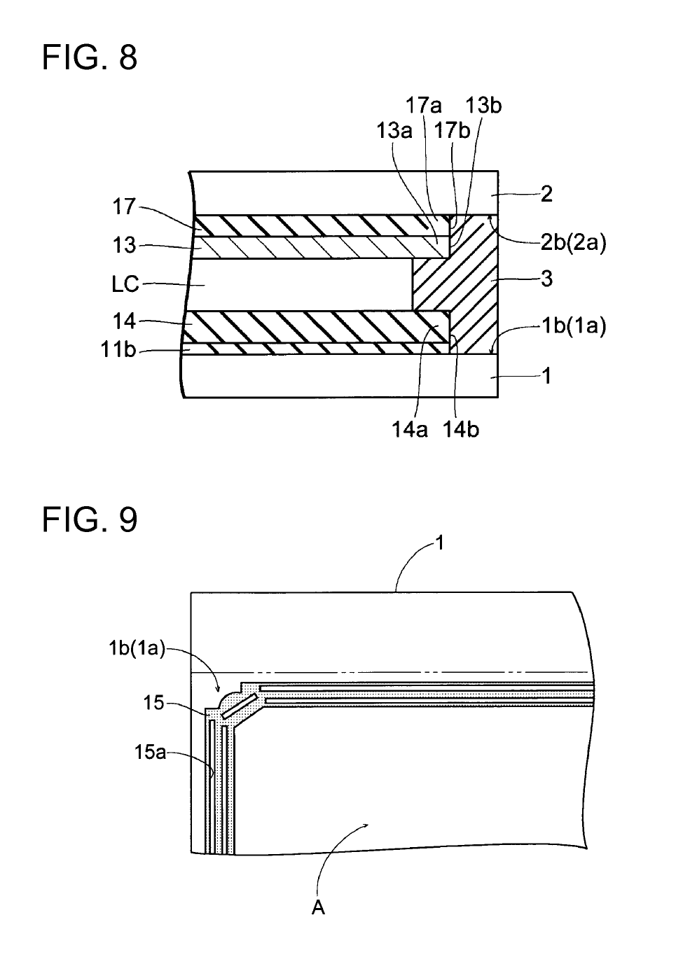

In the present embodiment, as shown in FIG. 8, in the four portions (four portions respectively corresponding in position to the four corners 2b of the glass substrate 2) 1b of the prescribed surface 1a of the glass substrate 1, the sealing member 3 is directly bonded to the prescribed surface 1a of the glass substrate 1. The sealing member 3 is also directly bonded to the prescribed surface 2a of the glass substrate 2 in the four corners 2b of the prescribed surface 2a of the glass substrate 2.

In the present embodiment, of the cut-outs 14b of the interlayer insulating film 14, the cut-outs 17b of the black matrix layer 17, and the cut-outs 13b of the opposite electrode 13, the cut-outs 14b of the interlayer insulating film 14 and the cut-outs 13b of the opposite electrode 13 are the same shape. However, the configuration is not limited thereto, and a configuration may be used in which the cut-outs 14b of the interlayer insulating film 14, the cut-outs 17b of the black matrix layer 17, and the cut-outs 13b of the opposite electrode 13 are all given different shapes, or in which the cut-outs 14b of the interlayer insulating film 14, the cut-outs 17b of the black matrix layer 17, and the cut-outs 13b of the opposite electrode 13 all have the same shape.

The fact that the common wiring line 15 (refer to FIG. 9) and the pad electrodes 16 (refer to FIG. 4) are provided on the glass substrate 1 was already mentioned, and the pad electrodes 16 (common wiring line 15) provided on the glass substrate 1 supply an electrical signal to the opposite electrode 13 provided on the glass substrate 2 through the sealing member 3.

In order for the pad electrodes 16 (common wiring line 15) to supply an electrical signal to the opposite electrode 13 through the sealing member 3, in the present embodiment, the sealing member 3 is made electrically conductive by mixing conductive particles (elastic bodies coated in gold or silver, for example) into the sealing member 3. The pad electrodes 16 (common wiring line 15) overlap the sealing member 3 and the opposite electrode 13. As a result, when an electrical signal is inputted into the pad electrodes 16 from the common wiring line 15, this electrical signal is transmitted to the opposite electrode 13 through the sealing member 3.

However, because in the present embodiment the four portions (four portions respectively corresponding in position to the four corners 2b of the glass substrate 2) 1b of the prescribed surface 1a of the glass substrate 1 are exposed, as shown in FIG. 9, the common wiring line 15 is drawn so as to avoid the four portions 1b of the prescribed surface 1a of the glass substrate 1. As shown in FIG. 4, for a similar reason, the pad electrodes 16 are disposed in portions other than the four portions (portions that respectively correspond to the four portions 1b of the prescribed surface 1a of the glass substrate 1; portions where the cut-outs 14b are formed) 14a of the interlayer insulating film 14.

As shown in FIG. 9, the common wiring line 15 has a plurality of slits (openings) 15a formed therein. By forming the slits 15a in the common wiring line 15, when curing the sealing member 3 by irradiating the sealing member 3 with UV (ultraviolet) rays, the UV passes through the slits 15a of the common wiring line 15. Thus, the step of curing the sealing member 3 can be conducted efficiently.

In the present embodiment, as described above, by forming cut-outs 14b in portions 14a of the interlayer insulating film (film formed on the prescribed surface 1a of the glass substrate 1) 14 that correspond in position to the corners 2b of the glass substrate 2, portions (portions overlapping portions of the sealing member 3) 1b of the prescribed surface 1a of the glass substrate 1 that correspond in position to the corners 2b of the glass substrate 2 are exposed, and thus, the sealing member 3 can be directly bonded to the portions 1b of the prescribed surface 1a of the glass substrate 1. In addition, cut-outs 17b are also formed in the portions 17a of the black matrix layer 17 at the corners 2b of the glass substrate 2 and cut-outs 13b are also formed in portions 13a of the opposite electrode 13 at the corners 2b of the glass substrate 2, and thus, the corners (portions overlapping portions of the sealing member 3) 2b of the prescribed surface 2a of the glass substrate 2 are also exposed. Thus, the sealing member 3 can be directly bonded to the corners 2b of the prescribed surface 2a of the glass substrate 2. As a result, the adhesive strength between the glass substrate 1 and the glass substrate 2 is increased.

If the adhesive strength between the glass substrate 1 and the glass substrate 2 can be increased, then leakage of the liquid crystal layer LC from between the glass substrate 1 and the glass substrate 2 can be mitigated.

If normally unnecessary cut-outs (openings) are formed in the black matrix layer 17, then there is a risk that light would leak through, causing a negative visual effect. However, in the present embodiment, cut-outs 17b are formed in portions of the black matrix layer 17 at the corners 2b of the glass substrate 2 (in other words, portions in the vicinity of the corners of the display region A), and thus there is not much effect visually.

Also, in the present embodiment, as described above, the four portions 1b of the prescribed surface 1a of the glass substrate 1 are exposed, and the sealing member 3 is directly bonded to all four portions 1b, and thus, the area in which the sealing member 3 is directly bonded to the prescribed surface 1a of the glass substrate 1 is increased. The four corners 2b of the prescribed surface 2a of the glass substrate 2 are exposed and the sealing member 3 is directly bonded to all four corners 2b, and thus, the area in which the sealing member 3 is directly bonded to the prescribed surface 2a of the glass substrate 2 is also increased. Therefore, the adhesive strength between the glass substrate 1 and the glass substrate 2 is further increased.

In the present embodiment, as stated above, the pad electrodes 16 are disposed in portions other than the four portions (portions where the cut-outs 14b are formed) 14a of the interlayer insulating film 14, and thus, the four portions (portions where the sealing member 3 is to be directly bonded) 1b of the prescribed surface 1a of the glass substrate 1 are not blocked by the pad electrodes 16. In addition, the common wiring line 15 is drawn so as to avoid the four portions 1b of the prescribed surface 1a of the glass substrate 1, and thus, the four portions 1b of the prescribed surface 1a of the glass substrate 1 are not blocked by the common wiring line 15. As a result, the sealing member 3 can be directly bonded to the four portions 1b of the prescribed surface 1a of the glass substrate 1 with ease.

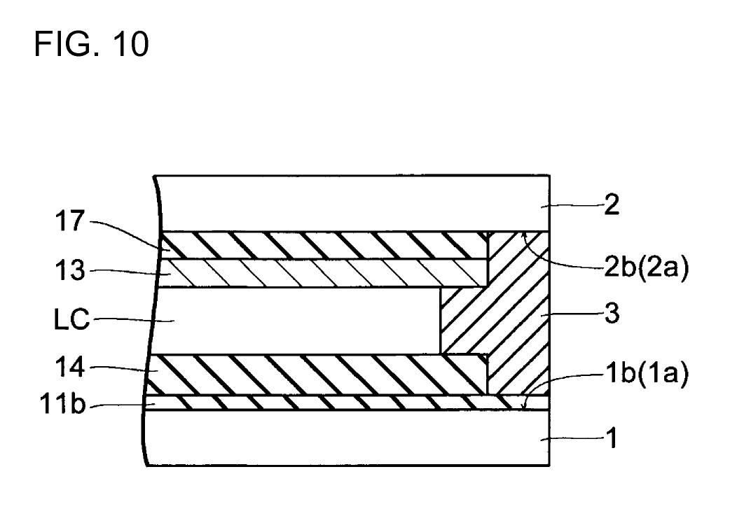

In the embodiment above, a configuration may be used in which instead of the sealing member 3 being bonded to the prescribed surface 1a of the glass substrate 1, a surface of the gate insulating film 11b is exposed and the sealing member 3 is bonded onto the surface of the gate insulating film 11b as shown in FIG. 10. However, it is more preferable that the sealing member 3 be bonded to the prescribed surface 1a of the glass substrate 1.

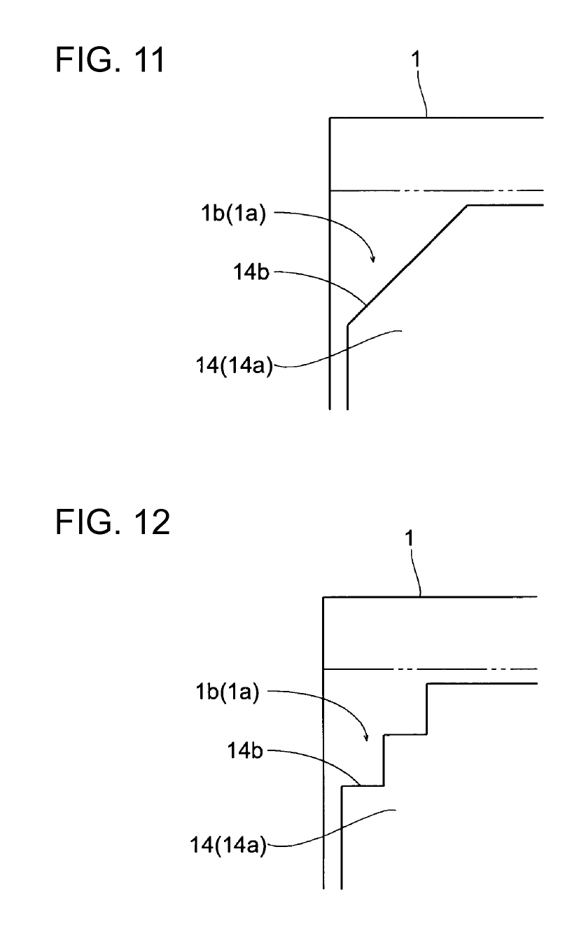

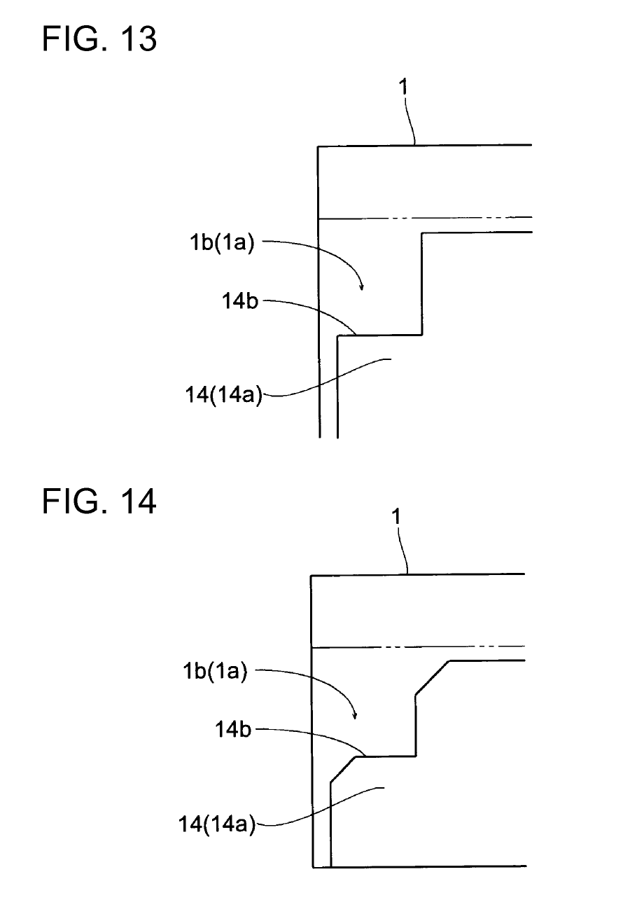

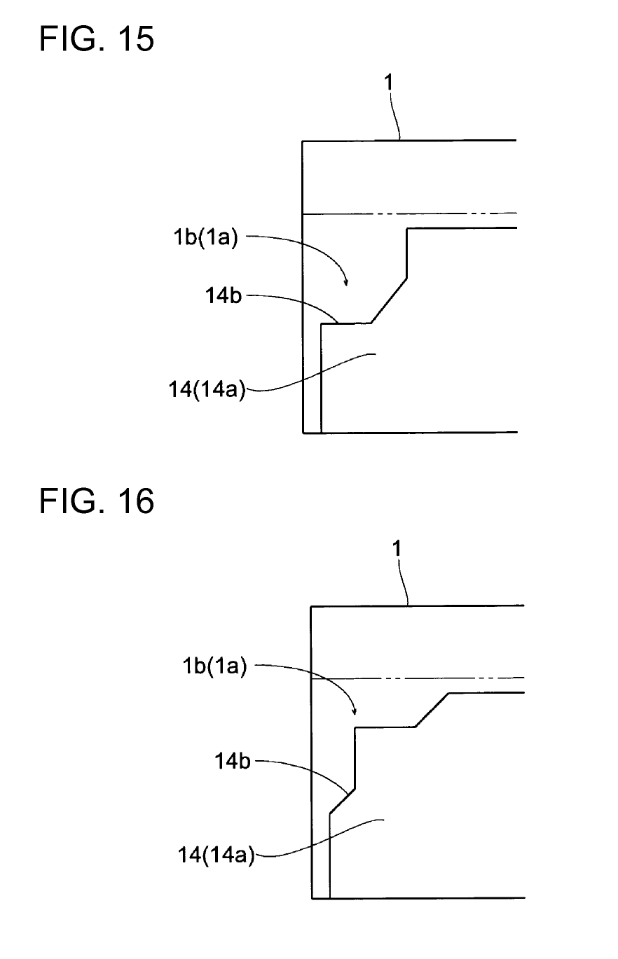

In the configuration of the embodiment above, the shape of the cut-outs 14b of the interlayer insulating film 14 may be modified. For example, as shown in FIG. 11, the cut-outs may have a straight diagonal line. As shown in FIGS. 12 and 13, the cut-outs may have bends so as to form a step shape. As shown in FIG. 14, the cut-outs may be triangular, and as shown in FIG. 15, the cut-outs may be trapezoidal. As shown in FIG. 16, some of the portion 14a may protrude into the cut-outs in a triangular shape.

In the configuration of the embodiment above, modifications in shape shown in FIGS. 11 to 16 can be applied to the cut-outs 17b of the black matrix layer 17 and the cut-outs 13b of the opposite electrode 13.

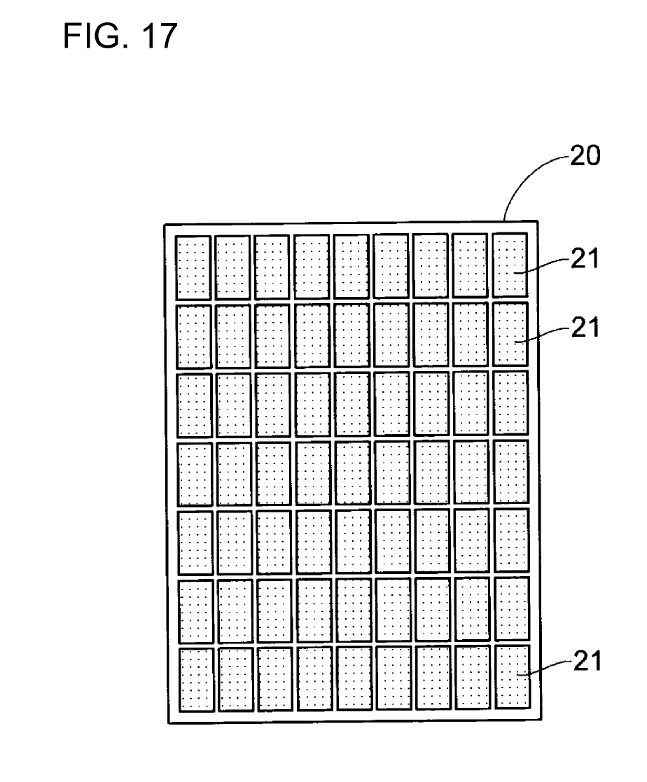

As shown in FIG. 17, a manufacturing method for the opposite substrate is widely known in which, after the black matrix layer and the color filter layers are formed on the mother glass 20, an ITO layer (layer to be the opposite electrodes) 21 is layered thereon using a metal mask with openings corresponding to the plan view shape of the opposite electrodes.

However, in a method in which a metal mask is used, there are limits on how narrow the mask can be made when taking the strength thereof into account, and patterning cannot be conducted in a precise manner. For example, while it is possible to set the width of the mask at approximately 3 mm, if this is done, unnecessarily wide spaces are formed between adjacent ITO layers 21, which decreases the number of opposite substrates that can be obtained from one mother glass 20. In addition, a step of removing extra regions (a separation step, for example) is necessary.

As a countermeasure, when manufacturing a narrow frame liquid crystal display panel (a liquid crystal display panel in which the distance from the edge thereof to the display region is 2 mm or less, for example), a configuration may be used in which the opposite substrate is manufactured using photolithography, which is widely known as a manufacturing method for the TFT substrate. In other words, when forming the opposite electrode on the mother glass 20, the ITO layer 21 on the mother glass 20 simply needs to be patterned using photolithography. As a result, a narrow frame liquid crystal display panel can be obtained with ease.

The embodiment disclosed herein is an example in every respect and is not limiting. The scope of the present invention is shown in the claims and not the embodiment described above, and in addition, all modifications within the equivalent meaning and scope of the claims are included.

### DESCRIPTION OF REFERENCE CHARACTERS

1 glass substrate (first substrate)

1a prescribed surface (first surface)

2 glass substrate (second substrate)

2a prescribed surface (second surface)

2b corner

3 sealing member

10 liquid crystal display panel (display panel)

11 switching element

12 pixel electrode

13 opposite electrode

13a portion (portion of opposite electrode at corner of second substrate)

13b cut-out

14 interlayer insulating film

14a portion (portion of interlayer insulating film corresponding in position to corner of second substrate)

14b cut-out

15 common wiring line

16 pad electrode

17 black matrix layer

17a portion (portion of black matrix layer at corner of second substrate)

17b cut-out

1. A display panel, comprising:
a first substrate having a first surface, the first surface having formed thereon switching elements connected to pixel electrodes and an insulating film covering the switching elements;
a second substrate having a second surface facing the first surface, the second surface having formed thereon a black matrix layer as a light-shielding layer and an opposite electrode that generates an electric field between the opposite electrode and the pixel electrodes; and
a sealing member disposed between the first substrate and the second substrate along an outer periphery of the second substrate that includes a corner thereof, the sealing member bonding together the first substrate and the second substrate,
wherein a cut-out is formed in a portion of the insulating film corresponding in position to the corner of the second substrate, and
wherein cut-outs are respectively formed in a portion of the black matrix layer at the corner of the second substrate and a portion of the opposite electrode at the corner of the second substrate.

2. The display panel according to claim 1,
wherein the second substrate has a plurality of corners,
wherein the cut-out is formed in every portion of the insulating film corresponding in position to each of the plurality of corners of the second substrate, and
wherein the cut-out is formed in every portion of the black matrix layer positioned at each of the plurality of corners of the second substrate, and in every portion of the opposite electrode positioned at each of the plurality of corners of the second substrate.

3. The display panel according to claim 1, further comprising pad electrodes disposed on the insulating film, the pad electrodes supplying an electrical signal to the opposite electrode,
wherein the pad electrodes are disposed on portions of the insulating film other than the portion where the cut-out is formed.

4. The display panel according to claim 3, further comprising a common wiring line disposed on the first surface of the first substrate, the common wiring line being connected to the pad electrodes,
wherein the common wiring line is drawn so as to avoid the portion of the first surface of the first substrate corresponding in position to the corner of the second substrate.

5. The display panel according to claim 1,
wherein the cut-out is formed in a portion of the outer periphery of the black matrix layer surrounding a display region, and
wherein a minimum distance from an edge of the outer periphery of the black matrix layer to the display region in a portion where the cut-out is formed is no less than a minimum distance from an edge of the outer periphery of the black matrix layer to the display region in a portion where the cut-out is not formed.

6. The display panel according to claim 1, wherein, among the cut-out of the insulating film, the cut-out of the black matrix layer, and the cut-out of the opposite electrode, at least two thereof are the same shape.

7. A display device, comprising the display panel according to claim 1.
